(19) United States
(12) Patent Application Publication
(10) Pub. No.: US 2013/0132766 A1
(43) Pub. Date: May 23, 2013

(54) METHOD AND APPARATUS FOR FAILOVER AND RECOVERY IN STORAGE CLUSTER SOLUTIONS USING EMBEDDED STORAGE CONTROLLER

(71) Applicants: Rajiv Bhatia, Bangalore (IN); Ankit Sihare, Bangalore (IN)

(72) Inventors: Rajiv Bhatia, Bangalore (IN); Ankit Sihare, Bangalore (IN)

(21) Appl. No.: 13/303,535

(22) Filed: Nov. 23, 2011

(51) Int. Cl. G06F 11/20

(52) U.S. Cl. 714/5.11; 714/E11.078

(57) ABSTRACT

Disclosed is a storage enclosure having a plurality of servers each having a storage controller. A second storage controller that is not part of any of the plurality of servers is embedded in the storage enclosure. The second storage controller is configured to process I/O commands directed to one of the server's storage controllers when a storage controller fails. In this manner, the storage controllers that are part of the servers may be fully utilized and still have a failover capability to the enclosure storage controller instead of another server storage controller that may also be fully utilized.

### BACKGROUND OF THE INVENTION

Mass storage systems continue to provide increased storage capacities to satisfy user demands. Photo and movie storage, and photo and movie sharing are examples of applications that fuel the growth in demand for larger and larger storage systems.

A solution to these increasing demands is the use of arrays of multiple inexpensive disks. These arrays may be configured in ways that provide redundancy and error recovery without any loss of data. These arrays may also be configured to increase read and write performance by allowing data to be read or written simultaneously to multiple disk drives. These arrays may also be configured to allow “hot-swapping” which allows a failed disk to be replaced without interrupting the storage services of the array. Whether or not any redundancy is provided, these arrays are commonly referred to as redundant arrays of independent disks (or more commonly by the acronym RAID). The 1987 publication by David A. Patterson, et al., from the University of California at Berkeley titled “A Case for Redundant Arrays of Inexpensive Disks (RAID)” discusses the fundamental concepts and levels of RAID technology.

RAID storage systems typically utilize a controller that shields the user or host system from the details of managing the storage array. The controller makes the storage array appear as one or more disk drives (or volumes). This is accomplished in spite of the fact that the data (or redundant data) for a particular volume may be spread across multiple disk drives.

### SUMMARY OF THE INVENTION

An embodiment of the invention may therefore comprise a storage system, comprising: a storage enclosure having a plurality of servers each having a storage controller, a first server of the plurality of servers having a first storage controller; and, a second storage controller that is not part of any of the plurality of servers, the second storage controller integrated into the storage enclosure, the second storage controller to process I/O commands directed to the first storage controller when the first storage controller fails.

An embodiment of the invention may therefore further comprise a method of operating a storage system, comprising: receiving I/O commands directed to a first storage controller of a first server of a plurality of servers, the plurality of servers being in a storage enclosure; determining that said first storage controller has failed; and, configuring a second storage controller integrated with said storage enclosure to process I/O commands directed to said first storage controller.

### BRIEF DESCRIPTION OF THE DRAWINGS

FIG. 1 is a block diagram of a storage system.

FIG. 2 is a flowchart of a method of operating a storage system.

FIG. 3 is a flowchart of a method of operating a storage system.

FIG. 4 is a block diagram of a computer system.

### DETAILED DESCRIPTION OF THE EMBODIMENTS

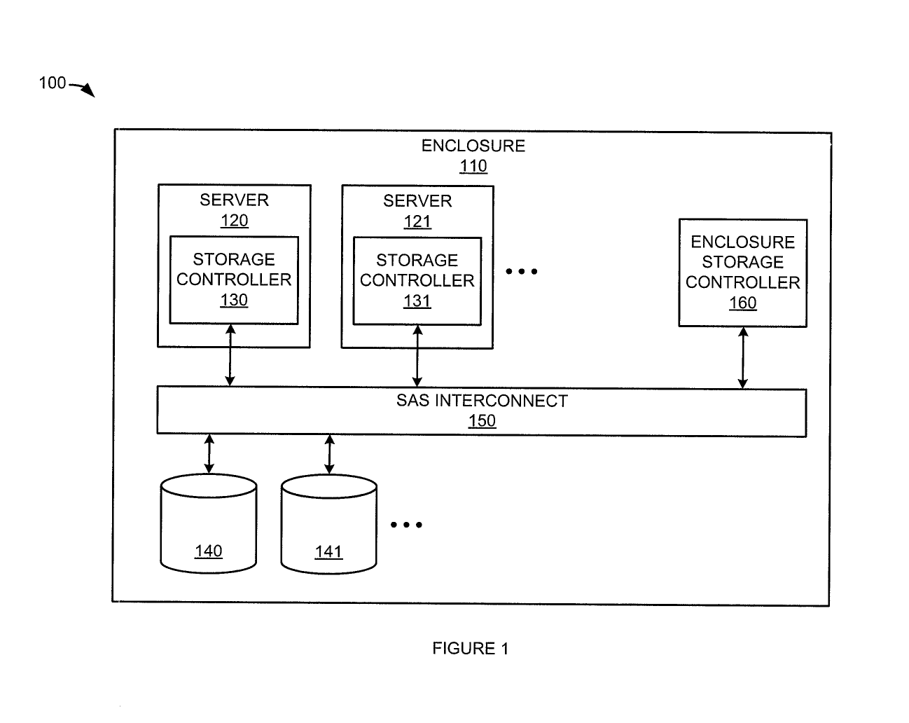

FIG. 1 is a block diagram of a storage system. In FIG. 1, storage system 100 comprises enclosure 110, server 120, server 121, serial attached SCSI (SAS) interconnect 150, a plurality of disk drives 140-141, and enclosure storage controller 160. Server 120 include storage controller 130. Server 121 includes storage controller 131.

Server 120 and storage controller 130 are operatively coupled to SAS interconnect 150. Server 121 and storage controller 131 are operatively coupled to SAS interconnect 150. Disk drives 140-141 are operatively coupled to SAS interconnect 150. Enclosure storage controller 160 is operatively coupled to SAS interconnect 150. Thus, server 120 may exchange I/O data with disk drives 140-141, storage controller 130, SAS interconnect 150, and enclosure storage controller 160. Server 121 may exchange I/O data with disk drives 140-141, storage controller 131, SAS interconnect 150, and enclosure storage controller 160. Enclosure storage controller 160 may exchange I/O commands with servers 120-121 and disk drives 140-141.

Storage controllers 130-131 and enclosure storage controller 160 (a.k.a., host controller, host bus adapters, or host adapter) connect a server 120-121 to SAS interconnect 150 and thus disk drives 140-141. Storage controllers 130-131 and enclosure storage controller 160 can bridge the physical, logical, and protocol differences between a server's 120-121 internal bus and external communication link(s), such as SAS interconnect 150. Storage controllers 130-131 and enclosure storage controller 160 may contain all the electronics and firmware required to execute transactions on the external communication link(s).

In FIG. 1, two servers 120-121 are shown, and one enclosure storage controller 160 is shown. However, this is merely exemplary. It should be understood that storage system 100 may have as little as one server in enclosure 110. It should be understood that storage system 100 may have more than two servers in enclosure 110. It should also be understood that storage system 100 may have more than one enclosure storage controller 160.

In an embodiment, enclosure storage controller 160 is embedded in enclosure 110. In other words, enclosure storage controller 160 is not part of server 120 or server 121. Embedded storage controller 160 may have an embedded real-time operating system (RTOS). The RTOS running on enclosure storage controller 160 may run while enclosure 110 is powered up. The RTOS running on enclosure storage controller 160 may manage a configuration table and perform RAID functions.

The configuration table maintained by enclosure storage controller 160 may have configuration information for all of the other storage controllers in enclosure 110 (e.g., storage controller 130 and storage controller 131). This configuration table may be maintained by the RTOS running on enclosure storage controller 160.

In an embodiment, enclosure storage controller 160 may detect when storage controller 130 or storage controller 131 has a fatal error (i.e., storage controller 130 or storage controller 131 has failed). Enclosure storage controller 160 may detect when storage controller 130 or storage controller 131 has a fatal error by determining that storage controller 130 or storage controller 131 has stopped processing I/O commands. Enclosure storage controller 160 may then refer to the configuration table to retrieve the configuration information of the failed storage controller. Enclosure storage controller 160 may use the configuration information of the failed storage controller to configure itself with the same configuration as the failed storage controller. Once configured with the same configuration as the failed storage controller, enclosure storage controller 160 can perform the tasks of the failed storage controller. This allows fail over from the failed storage controller to the enclosure storage controller 160. This fail over may be accomplished even though the failed storage controller was configured with a maximum number of virtual disks.

In an embodiment, once enclosure storage controller 160 resumes I/O processing in place of the failed storage controller, a system administrator would be informed that a storage controller has failed. A system administrator may be informed that a storage controller has failed by a log available in a management application.

It should be understood that by embedding enclosure storage controller 160 in enclosure 110, both storage controller 130 and storage controller 131 may be configured to be fully utilized (i.e., configured with their maximum number of virtual disks). When one of storage controller 130 or storage controller 131 fails, this condition may be detected by enclosure storage controller 160 or some other resource (e.g., server 120 or server 121) of enclosure 110. The I/O commands etc. that were previously being directed to the failed storage controller may then be shifted to enclosure storage controller 160. This allows processing of the I/O commands to continue.

It can be seen from FIG. 1, and the foregoing discussion, that storage system 100 has a plurality of servers 120-121 each having a storage controller 130-131. Enclosure 110 also has a redundant storage controller (enclosure storage controller 160) that is not part of the plurality of servers 120-121. Storage system 100 is configured to have enclosure storage controller 160 process I/O commands directed to one of storage controllers 130-131 when one of those storage controllers 130-131 fails. Enclosure storage controller 160 may run a RTOS. This RTOS may instruct enclosure storage controller 160 to maintain (i.e., store) a copy (or table) of each of the configurations of storage controllers 130-131. This configuration information may be used by enclosure storage controller 160 to process I/O command in place of a failed storage controller 130-131. In other words, when one of storage controllers 130-131 fails, enclosure storage controller 160 may use the configuration information it has stored to replicate the functionality of the failed storage controller. In the manner, storage controllers 130-131 may be configured with more than ½ the maximum number of virtual disks storage controllers 130-131 are capable of being configured with. Storage controllers 130-131 may be configured with more than ½ the maximum number of virtual disks storage controllers 130-131 are capable of being configured with and storage system 100 will be able to tolerate the failure of one of storage controllers 130-131. Enclosure storage controller 160 may determine that one of storage controller 130 or storage controller 131 has failed by detecting that I/O commands directed to storage controller 130 or storage controller 131 are not receiving responses.

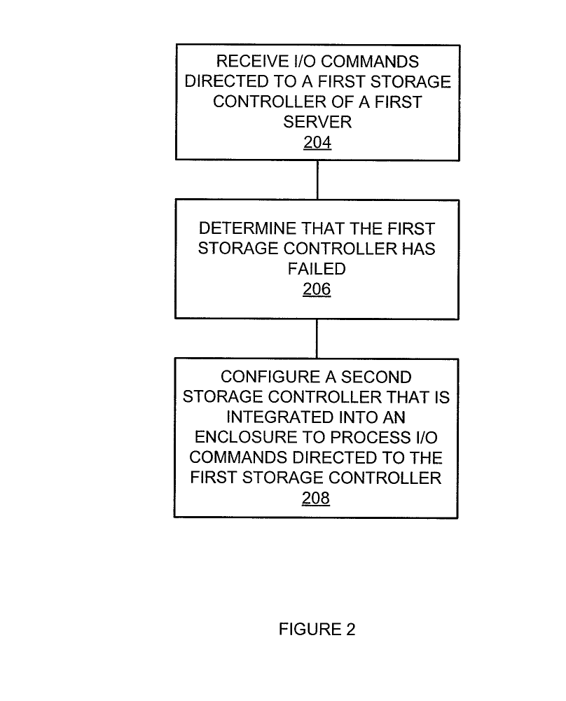

FIG. 2 is a flowchart of a method of operating a storage system. The steps illustrated in FIG. 2 may be performed my one or more elements of storage system 100. I/O commands directed to a first storage controller of a first server are received (204). For example, storage controller 130 may receive I/O commands from server 120. The first storage controller is determined to have failed (206). For example, enclosure storage controller 160 may determine that storage controller 130 has failed. Enclosure storage controller 160 may determine that storage controller 130 has failed by detecting the I/O commands for the configuration associated with storage controller 130 have stopped. Enclosure storage controller 160 may determine that storage controller 130 has failed by detecting the I/O commands associated with the configuration associated with storage controller 130 are not receiving responses.

A second storage controller that is integrated into an enclosure is configured to process I/O commands directed to the first storage controller (208). For example, in response to determining that storage controller 130 has failed, enclosure storage controller 160 may be configured to process I/O commands directed to storage controller 130. Enclosure storage controller 160 may be configured to process I/O commands directed to storage controller 130 using configuration information about storage controller 130 maintained or stored by enclosure storage controller 160.

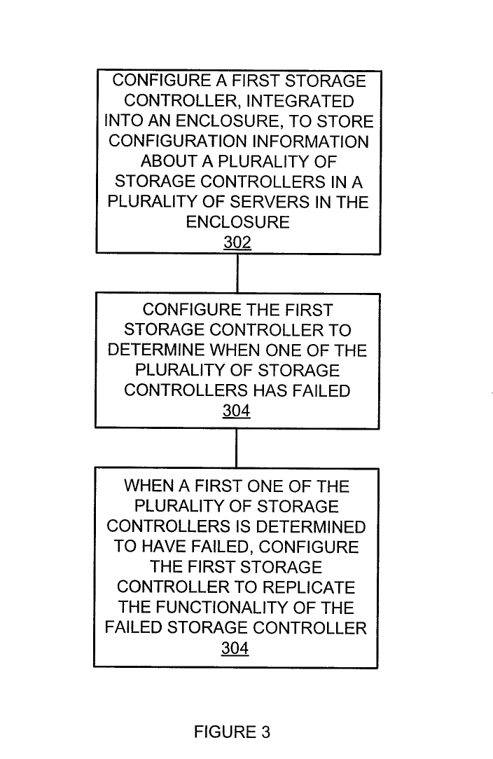

FIG. 3 is a flowchart of a method of operating a storage system. The steps illustrated in FIG. 3 may be performed by one or more elements of storage system 100. A first storage controller that is integrated into an enclosure is configured to store configuration information about a plurality of storage controllers in a plurality of servers in the enclosure (302). For example, enclosure storage controller 160 may be configured to store configuration information about storage controllers 130-131. Enclosure storage controller 160 may be running a RTOS in order to periodically poll or receive configuration information about storage controllers 130-131. Enclosure storage controller 160 may poll or receive configuration information about storage controllers 130-131 from servers 120-121, storage controllers 130-131, and/or a management application that controls all or part of storage system 100.

The first controller is configured to determine when one of the plurality of storage controller has failed (302). For example, enclosure storage controller 160 may be configured to determine when one of storage controllers 130-131 has failed. Enclosure storage controller 160 may be configured to determine when one of storage controllers 130-131 has failed by detecting when I/O commands to one of storage controllers 130-131 have stopped being processed.

When a first one of the plurality of storage controllers is determined to have failed, the first storage controller is configured to replicate the functionality of the failed storage controller (306). For example, if storage controller 130 is determined to have failed, enclosure storage controller 160 may be configured to replicate the functionality of storage controller 130. Enclosure storage controller 160 may be configured to replicate the functionality of storage controller 130 using the stored configuration information associated with storage controller 130. Enclosure storage controller 160 may be configured to replicate the functionality of storage controller 130 by configuring enclosure storage controller 160 with the stored configuration information associated with storage controller 130.

The methods, systems, networks, devices, equipment, and functions described above may be implemented with or executed by one or more computer systems. The methods described above may also be stored on a computer readable medium. Many of the elements of storage system 100, may be, comprise, or include computers systems. This includes, but is not limited to enclosure 110, server 120, server 121, SAS interconnect 150, disk drives 140-141, enclosure storage controller 160, storage controller 130, and storage controller 131.

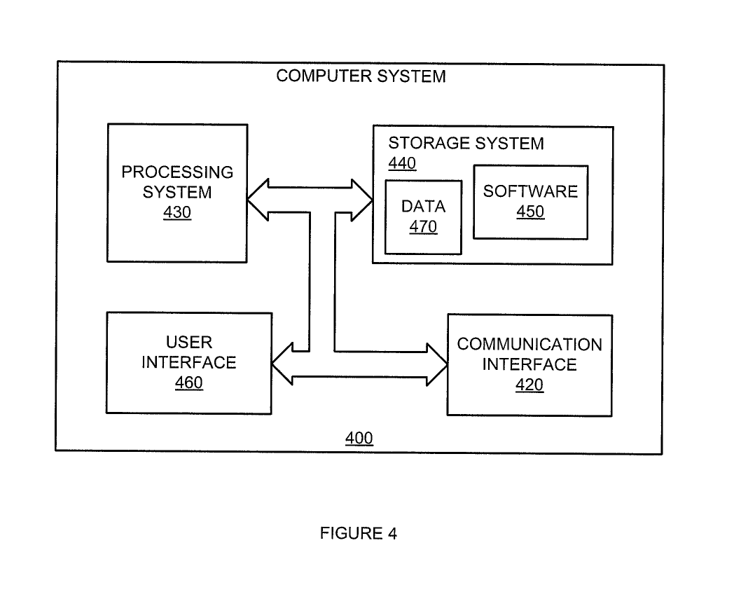

FIG. 4 illustrates a block diagram of a computer system. Computer system 400 includes communication interface 420, processing system 430, storage system 440, and user interface 460. Processing system 430 is operatively coupled to storage system 440. Storage system 440 stores software 450 and data 470. Processing system 430 is operatively coupled to communication interface 420 and user interface 460. Computer system 400 may comprise a programmed general-purpose computer. Computer system 400 may include a microprocessor. Computer system 400 may comprise programmable or special purpose circuitry. Computer system 400 may be distributed among multiple devices, processors, storage, and/or interfaces that together comprise elements 420-470.

Communication interface 420 may comprise a network interface, modem, port, bus, link, transceiver, or other communication device. Communication interface 420 may be distributed among multiple communication devices. Processing system 430 may comprise a microprocessor, microcontroller, logic circuit, or other processing device. Processing system 430 may be distributed among multiple processing devices. User interface 460 may comprise a keyboard, mouse, voice recognition interface, microphone and speakers, graphical display, touch screen, or other type of user interface device. User interface 460 may be distributed among multiple interface devices. Storage system 440 may comprise a disk, tape, integrated circuit, RAM, ROM, network storage, server, or other memory function. Storage system 440 may be a computer readable medium. Storage system 440 may be distributed among multiple memory devices.

Processing system 430 retrieves and executes software 450 from storage system 440. Processing system 430 may retrieve and store data 470. Processing system 430 may also retrieve and store data via communication interface 420. Processing system 430 may create or modify software 450 or data 470 to achieve a tangible result. Processing system 430 may control communication interface 420 or user interface 460 to achieve a tangible result. Processing system may retrieve and execute remotely stored software via communication interface 420.

Software 450 and remotely stored software may comprise an operating system, utilities, drivers, networking software, and other software typically executed by a computer system. Software 450 may comprise an application program, applet, firmware, or other form of machine-readable processing instructions typically executed by a computer system. When executed by processing system 430, software 450 or remotely stored software may direct computer system 400 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A storage system, comprising:
a storage enclosure having a plurality of servers each having a storage controller, a first server of the plurality of servers having a first storage controller; and,
a second storage controller that is not part of any of the plurality of servers, the second storage controller integrated into the storage enclosure, the second storage controller to process I/O commands directed to the first storage controller when the first storage controller fails.

2. The storage system of claim 1, wherein the second storage controller runs an embedded real-time operating system.

3. The storage system of claim 1, wherein the second storage controller is to store configuration information associated with the first storage controller.

4. The storage system of claim 3, wherein, when the first storage controller fails, the second storage controller is to use the configuration information associated with the first storage controller to process I/O commands directed to the first storage controller.

5. The storage system of claim 3, wherein, when the first storage controller fails, the second storage controller is to use the configuration information associated with the first storage controller to replicate the functionality of the first storage controller.

6. The storage system of claim 1, wherein the first storage controller is configured with more than ½ of a maximum number of virtual disks.

7. The storage system of claim 1, wherein the second storage controller determines the first storage controller has failed by detecting that I/O commands directed to said first storage controller are not receiving responses.

8. A method of operating a storage system, comprising:
receiving I/O commands directed to a first storage controller of a first server of a plurality of servers, the plurality of servers being in a storage enclosure;
determining that said first storage controller has failed; and,
configuring a second storage controller integrated with said storage enclosure to process I/O commands directed to said first storage controller.

9. The method of claim 8, wherein the second storage controller runs an embedded real-time operating system.

10. The method of claim 8, wherein the second storage controller maintains configuration information associated with the first storage controller.

11. The method of claim 10, further comprising:
using the configuration information associated with the first storage controller to process I/O commands directed to the first storage controller.

12. The method of claim 10, wherein, when the first storage controller fails, the second storage controller is to use the configuration information associated with the first storage controller to replicate the functionality of the first storage controller.

13. The method of claim 8, wherein the first storage controller is configured with more than ½ of a maximum number of virtual disks.

14. The method of claim 8, wherein the second storage controller determines the first storage controller has failed by detecting that I/O commands directed to said first storage controller are not receiving responses.

15. A non-transitory computer readable medium having instructions stored thereon for operating a storage system that, when executed by a computer, at least instruct the computer to:
receive I/O commands directed to a first storage controller of a first server of a plurality of servers, the plurality of servers being in a storage enclosure;
determine that said first storage controller has failed; and,
configure a second storage controller integrated with said storage enclosure to process I/O commands directed to said first storage controller.

16. The computer readable medium of claim 15, wherein the second storage controller runs an embedded real-time operating system.

17. The computer readable medium of claim 15, wherein the second storage controller maintains configuration information associated with the first storage controller.

18. The computer readable medium of claim 17, wherein the computer is further instructed to:
use the configuration information associated with the first storage controller to process I/O commands directed to the first storage controller.

19. The computer readable medium of claim 17, wherein, when the first storage controller fails, the second storage controller is to use the configuration information associated with the first storage controller to replicate the functionality of the first storage controller.

20. The computer readable medium of claim 15, wherein the first storage controller is configured with more than ½ of a maximum number of virtual disks.
